(19) United States
(12) Patent Application Publication
(10) Pub. No.: US 2025/0389253 A1
(43) Pub. Date: Dec. 25, 2025

(54) OFF-GRID WIND-HYDROGEN ENERGY SUPPLY SYSTEM FOR POLAR REGIONS AND CONTROL METHOD THEREOF

(71) Applicant: Polar Research Institute of China, Shanghai (CN)

(72) Inventors: Jingxue GUO, Shanghai (CN); Yuchen WANG, Shanghai (CN); Yinke DOU, Shanghai (CN); Runquan MENG, Shanghai (CN); Rui DONG, Shanghai (CN)

(21) Appl. No.: 19/245,780

(22) Filed: Jun. 23, 2025

(30) Foreign Application Priority Data
Jun. 21, 2024 (CN) 202410804254.2

(51) Int. Cl. F03D 9/19; F03D 7/04; F03D 9/11; F03D 9/30; F03D 17/00

(52) U.S. Cl. CPC F03D 9/19; F03D 7/045; F03D 9/11; F03D 9/30; F03D 17/005; F03D 17/021; F05B 2200/11; F05B 2220/61; F05B 2260/84; F05B 2270/8041

(57) ABSTRACT

Provided are an off-grid wind-hydrogen energy supply system for polar regions and a control method thereof, and relate to the field of new energy supply. In the system, wind energy is converted by a wind power generation system into electric energy, and a cryogenic battery energy storage system is charged. Chemical energy of hydrogen and oxygen is converted by a hydrogen fuel cell system into electric energy, and the cryogenic battery energy storage system is charged. Energy is stored by the cryogenic battery energy storage system, a wind power fluctuation is mitigated, and a load is smoothened. Operation parameters of the wind power generation system, the cryogenic battery energy storage system, and the hydrogen fuel cell system are obtained by an intelligent monitoring system.

### CROSS REFERENCE TO RELATED APPLICATION

This patent application claims the benefit and priority of Chinese Patent Application No. 202410804254.2, filed with the China National Intellectual Property Administration on Jun. 21, 2024, the disclosure of which is incorporated by reference herein in its entirety as part of the present application.

### TECHNICAL FIELD

The present disclosure relates to field of new energy supply, and in particular, relates to an off-grid wind-hydrogen energy supply system for polar regions and a control method thereof.

### BACKGROUND

Polar scientific exploration is an important field for people to explore nature's mysteries and seek new frontiers for development. This is an undertaking of lasting significance, benefiting both the present and future generations. With increase of Antarctic expeditions, energy utilization technology has become the top priority for ensuring the Antarctic expeditions.

In the Antarctic environment, electrical equipment in a clean energy system faces harsh natural conditions including an extremely cold condition, a blizzard condition with heavy snow load/severe sand-laden wind, low pressure and hypoxia, intense ultraviolet radiation, as well as extreme weather and unique phenomena like polar day/night cycles. Therefore, how to design and manufacture scientifically viable equipment including clean energy power generation equipment, hydrogen energy equipment, and the like to meet Antarctic energy demands is a formidable challenge. Due to the lack of systematic development and application of clean energy technologies for Antarctica's unique environmental characteristics, utilization of clean energy in Antarctica is currently in an exploratory phase. Developing wind and hydrogen power supply is crucial for resolving the fuel dependency and pollution problem of Antarctica resources. Therefore, enhancing adaptability of the Antarctic wind-hydrogen power supply system has become imperative.

### SUMMARY

An objective of the present disclosure is to provide an off-grid wind-hydrogen energy supply system for polar regions and a control method thereof, to stably and efficiently output electric energy in extreme environments such as an extremely cold condition, a blizzard condition with heavy snow load, and a condition with severe sand-laden wind, thereby improving utilization of renewable sources, and reducing fuel consumption and emission in Antarctic expeditions.

To achieve the above objective, the present disclosure provides the following solutions.

An off-grid wind-hydrogen energy supply system for polar regions includes:
a wind power generation system, a cryogenic battery energy storage system, a hydrogen fuel cell system, and an intelligent monitoring system, where
the wind power generation system, the cryogenic battery energy storage system, the hydrogen fuel cell system, and the intelligent monitoring system are connected through a direct-current bus;
the wind power generation system is configured to: convert wind energy into electric energy, and charge the cryogenic battery energy storage system;
the hydrogen fuel cell system is configured to: chemically convert hydrogen and oxygen into electric energy, and charge the cryogenic battery energy storage system;
the cryogenic battery energy storage system is configured to: store energy, mitigate a wind power fluctuation and smooth out a load fluctuation; and
the intelligent monitoring system is configured to obtain operation parameters of the wind power generation system, the cryogenic battery energy storage system, and the hydrogen fuel cell system.

Optionally, the wind power generation system includes a fastening bracket, a wind generator, and a controller module, where
the wind generator is mounted on the fastening bracket; the wind generator is connected to the controller module; and the wind turbine is separately connected to the wind power generation system, the hydrogen fuel cell system, and the intelligent monitoring system through the direct-current bus;
the wind generator is configured to: convert wind energy into electric energy, and charge the cryogenic battery energy storage system; and
the controller module is configured to: perform overcurrent limiting on the wind generator, and send the operation parameter of the wind generator to the intelligent monitoring system.

Optionally, the cryogenic battery energy storage system includes:
a cryogenic battery pack and a bidirectional energy storage converter, where
the cryogenic battery pack is connected to the bidirectional energy storage converter; and the bidirectional energy storage converter is separately connected to the wind power generation system, the hydrogen fuel cell system, and the intelligent monitoring system through the direct-current bus;
the cryogenic battery pack is configured to: store energy, mitigate a wind power fluctuation, and level a load fluctuation; and
the bidirectional energy storage converter is configured to perform direct-current conversion.

Optionally, the hydrogen fuel cell system includes:
a hydrogen controller, and an electrolytic hydrogen production unit, a hydrogen storage apparatus, and a hydrogen fuel cell power generator that are sequentially connected, where
the hydrogen fuel cell power generator is separately connected to the wind power generation system, the cryogenic battery energy storage system, and the intelligent monitoring system through the direct-current bus;
a switch is disposed between the hydrogen storage apparatus and the hydrogen fuel cell power generator;
the hydrogen controller is connected to the switch; and the hydrogen controller is configured to control an opening degree of the switch; and
the hydrogen fuel cell power generator is configured to: convert chemical energy of hydrogen and oxygen into electric energy, and charge the cryogenic battery energy storage system.

Optionally, the intelligent monitoring system includes:
a micro-meteorological station, a global positioning system (GPS) module, a camera, an iridium module, an industrial control module, an MSP430 module, a power measurement module, a power distribution unit (PDU) module, and an industrial controller, where
the GPS module, the camera, and the iridium module are all connected to the MSP430 module; the micro-meteorological station, the MSP430 module, the power measurement module, the PDU module, and the industrial controller are all connected to the industrial control module; the iridium module is connected to a remote monitoring system; the industrial controller is separately connected to the wind power generation system and the hydrogen fuel cell system; and the power measurement module is connected to the PDU module and a plurality of electric devices;
the micro-meteorological station is configured to monitor real-time meteorological data;
the GPS module is configured to obtain position information;
the camera is configured to obtain environmental image information;
the industrial control module is configured to transmit real-time meteorological data and position information to the MSP430 module;
the MSP430 module is configured to transmit real-time meteorological data, position information, and environmental image information to the remote monitoring system through the iridium module;
the iridium module is further configured to obtain a control instruction;
the MSP430 module is further configured to transmit the control instruction;
the industrial control module is configured to transmit the control instruction;
the PDU module is configured to query, power on, power off, or reboot power supply for the plurality of electric devices;
the power measurement module is configured to obtain power of the plurality of electric devices; and
the industrial controller is configured to: collect data of a wind turbine controller and a hydrogen energy controller, and perform control and instruction delivery.

A control method of an off-grid wind-hydrogen energy supply system for polar regions, where the method is applied to the off-grid wind-hydrogen energy supply system for polar regions, and the control method includes:
obtaining an operation parameter of a wind power generation system and an operation parameter of a cryogenic battery energy storage system;
constructing a wind turbine model based on the operation parameter of the wind power generation system;
constructing a storage battery model based on the operation parameter of the cryogenic battery energy storage system;
constructing a target function based on the wind turbine model and the storage battery model;
resolving, based on a constraint condition, the target function to minimize the target function, to obtain an optimal dispatch solution of the off-grid wind-hydrogen energy supply system for polar regions; and
dispatching the off-grid wind-hydrogen energy supply system for polar regions based on the optimal dispatch solution.

Optionally, the target function is:

$${C}_{total} = α {C}_{E} + β {C}_{R} ,$$

where

Cₜₒₜₐₗ is the target function; α and β are weights; C_{E} is economic cost;

$${C}_{E} = {C}_{W T}^{B u y} + {C}_{B S S}^{B u y} + {C}_{W T}^{o m} + {C}_{B S S}^{o m} ; {C}_{W T}^{B u y}$$

is wind turbine purchase cost,

$${C}_{B S S}^{B u y}$$

is storage battery purchase cost, C_{WT}^{om} is wind turbine operation cost,

$${C}_{B S S}^{o m}$$

is storage battery operation cost, and C_{R} is reliability cost; C_{R}=P_{cur}ρ_{cur}; P_{cur} is a load curtailment volume; and ρ_{cur} is load curtailment penalty cost.

Optionally, the constraint condition includes a power balance constraint, a wind turbine constraint, and a storage battery constraint;
the wind turbine constraint includes a wind turbine power constraint, and a first numerical constraint; and
the storage battery constraint includes a capacity-power relationship constraint, a charging/discharging constraint, a charging power constraint, a discharging power constraint, a storage battery capacity constraint, and a second numerical constraint.

Optionally, the power balance constraint is as follows:

$${P}_{wt} + {P}_{d e} + {P}_{dis} - {P}_{c h} = \sum {P}_{l o a d} - {P}_{c u r} ;$$

the wind turbine power constraint is as follows:

$$0 \leq {P}_{wt , t} \leq {N}_{wt} {P}_{wt}^{max} ;$$

the first numerical constraint is as follows:

$$1 \leq {N}_{wt} \leq {N}_{wt , max} ;$$

the capacity-power relationship constraint is as follows:

$${C}_{b s} ( t ) = ( 1 - δ ) {C}_{b s} ( t - 1 ) - {P}_{d i s} ( t ) / {η}_{d , b s} + {P}_{c h} {η}_{c , b s} ;$$

the charging/discharging constraint is as follows:

$${μ}_{c} + {μ}_{d} = 1 ;$$

the charging power constraint is as follows:

$$0 \leq {P}_{c h} \leq {μ}_{c} {P}_{c h}^{{max}_{b s}} ;$$

the discharging power constraint is as follows:

$$0 \leq {P}_{d i s} \leq {μ}_{d} {P}_{d i s}^{{max}_{b s}} ;$$

the storage battery capacity constraint is as follows:

$${N}_{bs} {C}_{bs , min} \leq {C}_{bs , t} \leq {N}_{bs} {C}_{bs , max} ;$$

the second numerical constraint is as follows:

$$0 \leq {N}_{bs} \leq {N}_{bs , max} ,$$

where

P_{wt} is an actual wind turbine power, P_{de} is an output power of a diesel generator, P_{dis} is a storage battery discharging power, P_{dis}(t) is a storage battery discharging power at a moment t, η_{d,bs} is a storage battery discharging power, P_{ch} is a storage battery charging power,

$${P}_{ch}^{max}$$

is a maximum charging power,

$${P}_{dis}^{max}$$

is a maximum discharging power, ΣP_{load} is a total system load, P_{cur} is a load curtailment volume, P_{wt, t} is an actual wind turbine power at a moment t, N_{wt} is a number of wind turbines, N_{wt,max} is a maximum wind turbine count, C_{bs}(t) is an actual storage battery capacity at the moment t, C_{bs, min} is a minimum storage capacity of the storage battery, C_{bs, max} is a maximum storage capacity of the storage battery, C_{bs}(t−1) is an actual storage battery capacity at a moment t−1, δ is a self-discharging power of the storage battery, n_{dis} is a discharging efficiency, n_{c,bs} is a charging efficiency, μₑ is a charging state, μ_{d} is a discharging state, N_{bs} is a number of storage batteries, and N_{bs,max} is a maximum storage battery count.

According to specific embodiments provided in the present disclosure, the present disclosure has the following technical effects:
According to the off-grid wind-hydrogen energy supply system for polar regions and the control method thereof provided in the present disclosure, wind power and hydrogen energy are combined based on an Antarctic environment to construct a basic framework of an integrated wind-hydrogen system, and an integrated Antarctic wind-hydrogen system is established by analyzing a working mode of the system. Rich polar wind power resources can be utilized to a greatest extent through the off-grid wind-hydrogen energy supply system for polar regions, reducing utilization of primary energy. In addition, integrated wind-hydrogen power generation is adopted by the system to convert wind power into hydrogen, effectively migrating a random fluctuation of wind power, and smoothening adverse effect of wind power to stability of the system.

### BRIEF DESCRIPTION OF THE DRAWINGS

To describe the technical solutions in embodiments of the present disclosure or in the prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is a structural block diagram of an off-grid wind-hydrogen energy supply system for polar regions according to an embodiment of the present disclosure;

FIG. 2 is a schematic structural diagram of an integrated wind-hydrogen power supply system according to an embodiment of the present disclosure;

FIG. 3 is a schematic structural diagram of an intelligent monitoring system according to an embodiment of the present disclosure; and

FIG. 4 is a schematic diagram of connection of a power distribution unit (PDU) module according to an embodiment of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other examples obtained by a person of ordinary skill in the art based on the examples of the present disclosure without creative efforts shall fall within the protection scope of the present disclosure.

An objective of the present disclosure is to provide an off-grid wind-hydrogen energy supply system for polar regions and a control method thereof, to stably and efficiently output electric energy in extreme environments such as an extremely cold condition, a blizzard condition with heavy snow load, and a condition with severe sand-laden wind, thereby improving utilization of renewable sources, and reducing fuel consumption and emission in Antarctic expeditions.

In order to make the above objective, features and advantages of the present disclosure clearer and more comprehensible, the present disclosure will be further described in detail below in combination with accompanying drawings and particular implementations.

### Embodiment 1

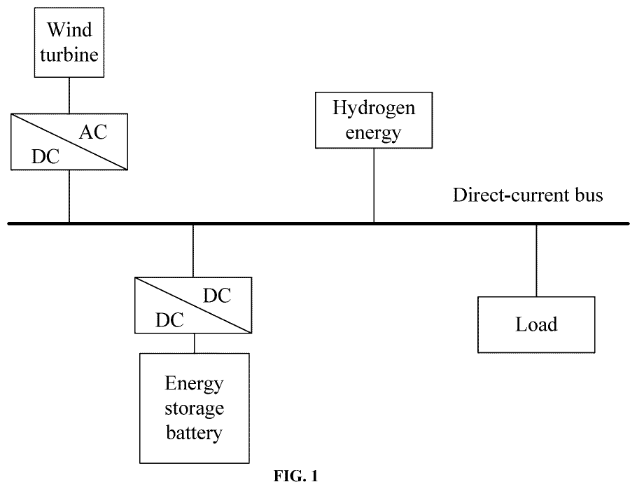

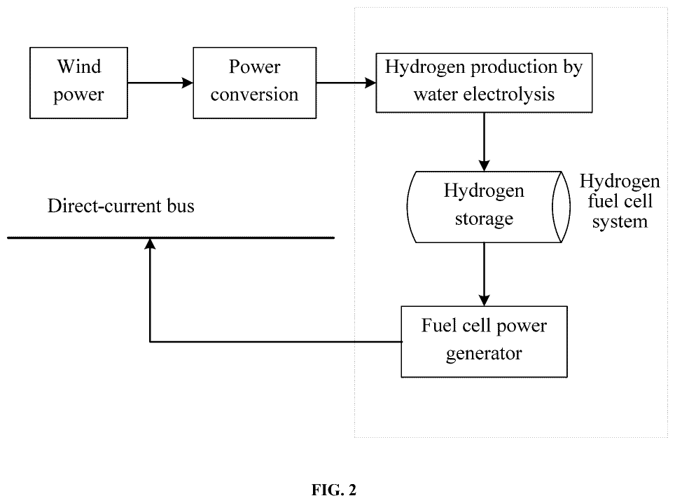

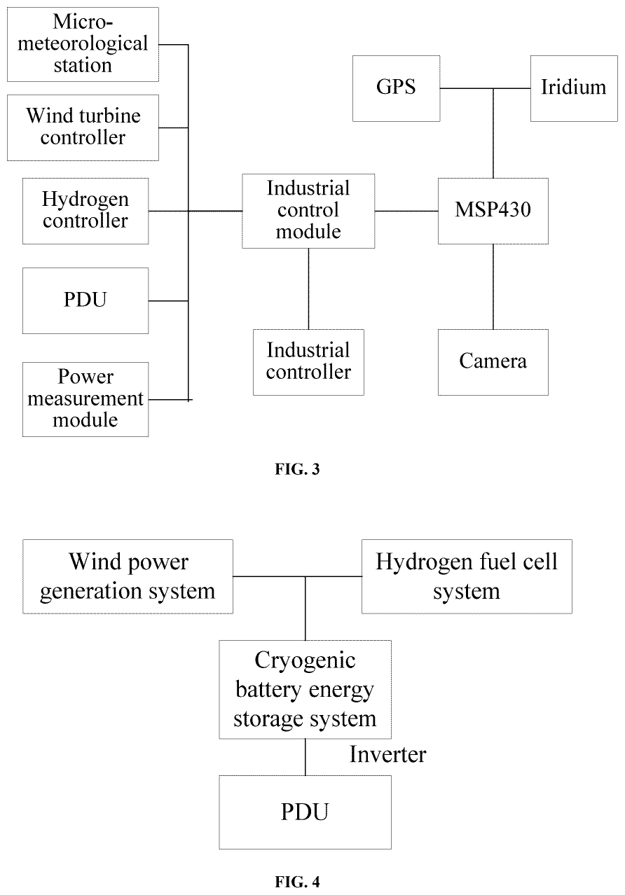

As shown in FIG. 1 to FIG. 4, an off-grid wind-hydrogen energy supply system for polar regions in this embodiment includes a wind power generation system, a cryogenic battery energy storage system, a hydrogen fuel cell system, and an intelligent monitoring system. The wind power generation system, the cryogenic battery energy storage system, the hydrogen fuel cell system, and the intelligent monitoring system are connected through a direct-current bus. The wind power generation system is configured to: convert wind energy into electric energy, and charge the cryogenic battery energy storage system. The hydrogen fuel cell system is configured to: convert chemical energy of hydrogen and oxygen into electric energy, and charge the cryogenic battery energy storage system. The cryogenic battery energy storage system is configured to: store energy, mitigate a wind power fluctuation, and level a load fluctuation. The intelligent monitoring system is configured to obtain operation parameters of the wind power generation system, the cryogenic battery energy storage system, and the hydrogen fuel cell system.

The wind power generation system includes a fastening bracket, a wind generator, and a controller module. The wind generator is mounted on the fastening bracket. The wind generator is connected to the controller module. The wind generator is separately connected to the wind power generation system, the hydrogen fuel cell system, and the intelligent monitoring system through the direct-current bus. The wind generator is configured to: convert wind energy into electric energy, and charge the cryogenic battery energy storage system. The controller module is configured to: perform overcurrent limiting on the wind generator, and send the operation parameter of the wind generator to the intelligent monitoring system.

The cryogenic battery energy storage system includes a cryogenic battery pack and a bidirectional energy storage converter. The cryogenic battery pack is connected to the bidirectional energy storage converter. The bidirectional energy storage converter is separately connected to the wind power generation system, the hydrogen fuel cell system, and the intelligent monitoring system through the direct-current bus. The cryogenic battery pack is configured to: store energy, mitigate a wind power fluctuation, and level a load fluctuation. The bidirectional energy storage converter is configured to perform direct-current conversion.

The hydrogen fuel cell system includes a hydrogen controller, and an electrolytic hydrogen production unit, a hydrogen storage apparatus, and a hydrogen fuel cell power generator that are sequentially connected. The hydrogen fuel cell power generator is separately connected to the wind power generation system, the cryogenic battery energy storage system, and the intelligent monitoring system through the direct-current bus. A switch is disposed between the hydrogen storage apparatus and the hydrogen fuel cell power generator. The hydrogen controller is connected to the switch. The hydrogen controller is configured to control an opening degree of the switch. The hydrogen fuel cell power generator is configured to: convert chemical energy of hydrogen and oxygen into electric energy, and charge the cryogenic battery energy storage system.

The intelligent monitoring system includes a micro-meteorological station, a global positioning system (GPS) module, a camera, an iridium module, an industrial control module, an MSP430 module, a power measurement module, a power distribution unit (PDU) module, and an industrial controller. The GPS module, the camera, and the iridium module are all connected to the MSP430 module. The micro-meteorological station, the MSP430 module, the power measurement module, the PDU module, and the industrial controller are all connected to the industrial control module. The iridium module is connected to a remote monitoring system. The industrial controller is separately connected to the wind power generation system and the hydrogen fuel cell system. The power measurement module is connected to the PDU module and a plurality of electric devices. The micro-meteorological station is configured to monitor real-time meteorological data. The GPS module is configured to obtain position information. The camera is configured to obtain environmental image information. The industrial control module is configured to transmit real-time meteorological data and position information to the MSP430 module. The MSP430 module is configured to transmit real-time meteorological data, position information, and environmental image information to the remote monitoring system through the iridium module. The iridium module is further configured to obtain a control instruction. The MSP430 module is further configured to transmit the control instruction. The industrial control module is configured to transmit the control instruction. The power distribution unit (PDU) module is configured to query, power on, power off, or reboot power supply for the plurality of electric devices. The power measurement module is configured to obtain power of the plurality of electric devices. The industrial controller is configured to: collect data of a wind turbine controller and a hydrogen energy controller, and perform control and instruction delivery.

Specifically, the wind power generation system includes a wind generator, and a controller module. The controller module includes a wind turbine controller, an RS485 communication module, and a dump load resistor. The dump load resistor is connected to the wind turbine controller through maximum power point tracking (MPPT) charging. The wind turbine controller is configured to provide overcurrent limiting. Once a current of a wind turbine exceeds a specified upper limit current, MPPT intelligent dump load is automatically started by the controller, to protect the wind turbine. The RS485 communication module is configured to: monitor the entire wind power generation system and transmit back data, and set parameters through a serial port. In the wind power generation system, wind energy is converted by the wind generator into electric energy, the direct-current bus is connected through a rectifier, and the cryogenic battery pack is charged by the controller. The wind generator is a vertical-axis spherical wind generator, needs to be installed with a fastening bracket, and has functions of resisting strong wind, a low temperature, and blizzard.

The cryogenic battery energy storage system includes the cryogenic battery pack and the bidirectional energy storage converter. The cryogenic battery pack is connected to the direct-current bus through the bidirectional energy storage converter. The cryogenic battery energy storage system is configured to: mitigate a wind power fluctuation and level a load fluctuation, thereby utilizing electric equipment more effectively, reducing power supply cost, and promoting application of new energy.

The hydrogen fuel cell system includes the hydrogen controller, the hydrogen storage apparatus, the electrolytic hydrogen production unit, and the hydrogen fuel cell power generator. The hydrogen fuel cell system is connected to the hydrogen storage apparatus through a hydrogen pipeline, and an electric power output is directly accessed into the direct-current bus. The hydrogen storage apparatus is a hydrogen storage tank with pressure of 10 Mpa and a storage temperature as low as −35° C. The hydrogen fuel cell controller carried on the hydrogen fuel cell system is configured to: control gas flow on-off, a temperature, load application/load curtailment. The electrolytic hydrogen production unit is configured to electrolyze water for hydrogen production by using excessive electric energy of the wind power generation system. The hydrogen fuel cell power generator is an apparatus for directly converting chemical energy of hydrogen and oxygen into electric energy. A fundamental principle is as follows: Hydrogen and oxygen are respectively supplied to an anode and a cathode through a reverse reaction of water electrolysis; and after hydrogen is diffused outwards through the anode to react with electrolyte, electrons are released to reach the cathode through an external load circuit. Power generation efficiency of the hydrogen fuel cell can be 50% or more, which is determined by conversion properties of a proton exchange membrane. Chemical energy is directly converted into electric energy without intermediate conversion of heat energy and mechanical energy (power generator).

The intelligent monitoring system includes the micro-meteorological station, the GPS module, the camera, the iridium module, the industrial control module, the MSP430 module, the power measurement module, the PDU module, and the industrial controller. The wind turbine controller, the hydrogen controller, the micro-meteorological station, the PDU module, and the power measurement module are separately connected to the industrial control module. The industrial control module is connected to the MSP430 module to implement remote communication through the iridium module, and the industrial control module is connected to the industrial controller to implement local instruction transmission. The wind power generation system and the hydrogen fuel cell system are connected to the cryogenic battery energy storage system that is connected to the PDU module through an inverter. The GPS module and the camera are remotely controlled through the iridium module and the MSP430 module.

In the intelligent monitoring system, the wind turbine controller and the hydrogen controller communicate with the industrial control module through the power measurement module. The industrial control module is connected to the MSP430 module to implement remote communication through the iridium module, so as to transmit data of the wind power generation system and a hydrogen energy system to a remote monitoring center. The micro-meteorological station is configured to: monitor real-time meteorological data and transmit back the real-time meteorological data to the remote monitoring center through the industrial control module and the MSP430 module, and modify parameters of the entire wind-hydrogen power supply system according to the real-time meteorological data. The PDU module is configured to: query, turn on, turn off or reboot power supply for each equipment at a port connected to the PDU module according to the instruction transmitted by the iridium module. The camera is configured to: observe a real-time image of the system, and transmit the real-time image.

The wind power generation system and the hydrogen fuel cell system form an integrated wind-hydrogen system. The wind power generation system is a clean energy system that is configured to convert wind energy into electric energy through the wind generator, charge the cryogenic battery pack through the controller, and supply load through the rectifier. As the wind power generation system has high power generation amount, extreme wind environments in coastal Antarctic regions cause problems in a conventional wind turbine, including blade fracture, wind turbine oscillation, and structural resonance damage to a supporting rod. Wind energy can be efficiently improved by the adopted vertical-axis spherical wind generator while operational reliability and environmental adaptability are effectively improved.

In terms of stability, the polar off-grid wind-hydrogen power generation system is more stable than an independent wind power generator. The hydrogen fuel cell system can be added to improve electric energy quality, migrate random fluctuation of wind power, and relieve adverse effect of the wind power on stability of the system. In terms of economic performance, in comparison with primary energy, wind power resources are utilized to electrolyze water for hydrogen production by using excessive wind power, store and transport hydrogen. Therefore, total energy consumption and logistic supply pressure are greatly reduced, and energy utilization is improved. In the off-grid wind-hydrogen power generation system, when wind power resources are sufficient, wind energy is converted into electric energy and is supplied to the load. In this case, a storage battery is in a charging mode through the bidirectional energy storage inverter. After the battery is fully charged, if there is excessive power of the wind turbine, a device is operated at a reduced capacity to prevent over-charging of the battery. In addition, excessive power is utilized to electrolyze water for hydrogen production. When wind resources are insufficient, power generation of the wind turbine cannot meet load usage. In this case, the load is powered by both wind energy and the storage battery. When there is no wind resource, the load is powered by the storage battery, and when a state of charge of the storage battery is insufficient, the load and the storage battery are charged by the hydrogen fuel cell power generator.

### Embodiment 2

A control method of an off-grid wind-hydrogen energy supply system for polar regions is provided in this embodiment. The method is applied to the off-grid wind-hydrogen energy supply system for polar regions in Embodiment 1, and the control method includes the following steps.

An operation parameter of a wind power generation system and an operation parameter of a cryogenic battery energy storage system are obtained.

A wind turbine model is constructed based on the operation parameter of the wind power generation system.

A storage battery model is constructed based on the operation parameter of the cryogenic battery energy storage system.

A target function is constructed based on the wind turbine model and the storage battery model.

The target function is resolved based on a constraint condition to minimize the target function, to obtain an optimal dispatch solution of the off-grid wind-hydrogen energy supply system for polar regions.

The off-grid wind-hydrogen energy supply system for polar regions is dispatched based on the optimal dispatch solution.

Modeling is performed on a wind turbine.

$$\frac{{P}_{WT}}{{P}_{WT 0}} = \frac{\frac{1}{8} ρ {D}^{2} {v}^{3} {C}_{p} {η}_{WT}}{\frac{1}{8} {ρ}_{0} {D}^{2} {v}^{3} {C}_{p} {η}_{WT}} = \frac{ρ}{{ρ}_{0}} . \qquad ( 1 )$$

$$ρ = \frac{P}{{RT}_{c}} . \qquad ( 2 )$$

$${P}_{WT 0} = \{ \begin{matrix}{aP}_{r} , & {v}_{ci} \leq v \leq {v}_{r} \\ {P}_{r} , & {v}_{r} \leq v \leq {v}_{co} \\ 0 , & v < {v}_{ci} or v > {v}_{co}\end{matrix} . \qquad ( 3 )$$

$$a = \frac{{v}^{3} - {v}_{ci}^{3}}{{v}_{r}^{3} - {v}_{ci}^{3}} . \qquad ( 4 )$$

$${P}_{WT} = \frac{ρ}{{ρ}_{0}} {P}_{WT 0} . \qquad ( 5 )$$

Herein, v_{ci} is a cut-in wind speed, generally 3 m/s (for reference only); V_{co} is a cut-out wind speed, generally 25 m/s (for reference only); vᵣ is a rated wind speed that is determined according to a specific wind turbine type, and is generally 11 m/s (for reference only). ρ₀ is an air density under a standard condition, and is generally 1.255 kg/m3. R is a universal gas constant, and is 8.314 J/(mol·K). P is atmospheric pressure, and annual average atmospheric pressure, obtained through query and calculation, at Zhongshan Station is 981.64 hPa. P_{WT} is an actual wind turbine power; P_{WT0} is an actual power of the wind turbine under the standard condition; ρ is air density; D is a damping coefficient; α is a wind speed; Cₚ is an actual wind energy utilization coefficient of the wind turbine; n_{WT} is a wind turbine power; T_{c} is a thermodynamic temperature; α is a cubic wind speed difference ratio; Pᵣ is a rated power of the wind turbine; C_{bat}(T) is an actual capacity of the storage battery at an environmental temperature T; K is a temperature coefficient; and T_{STC} is a standard temperature. Storage battery model:

Capacity:

$${C}_{bat} ( T ) = {C}_{STC} [ 1 + k ( T - {T}_{STC} ) ] . \qquad ( 6 )$$

Herein, K is 0.005-0.008° C.⁻¹; and C_{STC} is a rated capacity, and is 7.2 kWh.

Charge:

$$C ( t ) = C ( t - 1 ) ( 1 - δ ) - Δ {tP}_{ch} ( t ) {η}_{ch} . \qquad ( 7 )$$

Discharge:

$$C ( t ) = C ( t - 1 ) ( 1 - δ ) - Δ {tP}_{dis} ( t ) / {η}_{dis} . \qquad ( 8 )$$

Herein, C(t) is a capacity of the storage battery at a moment t; δ is a self-discharging rate of the storage battery; η_{dis} is discharging efficiency; and η_{ch} is charging efficiency.

A good coordination effect, a good environmental protection value, and a good economic value of the system are reflected by modeling the wind power generation system and the cryogenic battery energy storage system with minimum economic cost C_{E} and reliability cost C_{R} of a polar off-grid micro grid as the target function.

The target function is as follows:

$${C}_{total} = α {C}_{E} + β {C}_{R} ,$$

where

Cₜₒₜₐₗ is the target function; α and β are weights; C_{E} is economic cost;

$${C}_{E} = {C}_{WT}^{Buy} + {C}_{BSS}^{Buy} + {C}_{WT}^{om} + {C}_{BSS}^{om} ; {C}_{WT}^{Buy}$$

is storage battery purchase cost,

$${C}_{BSS}^{Buy}$$

is wind turbine purchase cost,

$${C}_{WT}^{om}$$

is wind turbine operation cost,

$${C}_{BSS}^{om}$$

is storage battery operation cost, and C_{R} is reliability cost; C_{R}=P_{cur}ρ_{cur}; P_{cur} is a load curtailment volume; and ρ_{cur} is load curtailment penalty cost.

α and β are respectively 0.4 and 0.6; P_{cur} is the load curtailment volume; ρ_{cur} is the load curtailment penalty cost, and is generally CNY 1000/W;

$${C}_{WT}^{Buy} and {C}_{BSS}^{Buy}$$

are the wind turbine acquisition post, and the storage battery acquisition post, and are respectively CNY 13000 per unit and CNY 450 per unit; and

$${C}_{WT}^{om} and {C}_{BSS}^{om}$$

are the wind turbine operation cost and the storage battery operation cost, and are CNY 1.3/W, and CNY 1.5/kWh. The constraint condition includes a power balance constraint, a wind turbine constraint, and a storage battery constraint.

The wind turbine constraint includes a wind turbine power constraint, and a first numerical constraint.

The storage battery constraint includes a capacity-power relationship constraint, a charging/discharging constraint, a charging power constraint, a discharging power constraint, a storage battery capacity constraint, and a second numerical constraint.

The power balance constraint is as follows:

$${P}_{wt} + {P}_{de} + {P}_{dis} - {P}_{ch} = \sum {P}_{load} - {P}_{cur} .$$

The wind turbine power constraint is as follows:

$$0 \leq {P}_{wt , t} \leq {N}_{wt} {P}_{wt}^{max} .$$

The first numerical constraint is as follows:

$$1 \leq {N}_{wt} \leq {N}_{wt , max} .$$

Herein,

$${P}_{wt}^{max}$$

is 1 kW, and n_{wt,max} is 2.

The capacity-power relationship constraint is as follows:

$${C}_{bs} ( t ) = ( 1 - δ ) {C}_{bs} ( t - 1 ) - {P}_{dis} ( t ) / {η}_{d , bs} + {P}_{ch} {η}_{c , bs} .$$

The charging/discharging constraint is as follows:

$${μ}_{c} + {μ}_{d} = 1.$$

The charging power constraint is as follows:

$$0 \leq {P}_{ch} \leq {μ}_{c} {P}_{ch}^{{max}_{bs}} .$$

The discharging power constraint is as follows:

$$0 \leq {P}_{dis} \leq {μ}_{d} {P}_{dis}^{{max}_{bs}} .$$

The storage battery capacity constraint is as follows:

$${N}_{bs} {C}_{bs , min} \leq {C}_{bs , t} \leq {N}_{bs} {C}_{bs , max} .$$

The second numerical constraint is as follows

$$0 \leq {N}_{bs} \leq {N}_{bs , max} .$$

Herein,

$${P}_{dis}^{max}$$

### is 1 KW, and N_{bs,max} is 3;

$${P}_{ch}^{max}$$

is 1 kW; C_{bs,max} is 7.2 kWh; and C(0) is 7.2*0.9 kWh.

P_{wt} is an actual wind turbine power, P_{de} is an output power of a diesel generator, P_{dis} is a storage battery discharging power, P_{dis}(t) is a storage battery discharging power at a moment t, η_{d,bs} is a storage battery discharging power, P_{ch} is a storage battery charging power,

$${P}_{ch}^{max}$$

is a maximum charging power,

$${P}_{dis}^{max}$$

is a maximum discharging power, ΣP_{load} is a total system load, P_{cur} is a load curtailment volume, P_{wt, t} is an actual wind turbine power at a moment t, N_{wt} is a number of wind turbines, N_{wt, max} is a maximum wind turbine count, C_{bs}(t) is an actual storage battery capacity at the moment t, C_{bs,min} is a minimum storage capacity of the storage battery, C_{bs, max} is a maximum storage capacity of the storage battery, C_{bs}(t−1) is an actual storage battery capacity at a moment t−1, δ is a self-discharging power of the storage battery, η_{dis} is a discharging efficiency, Θ_{c,bs} is a charging efficiency, μ_{c} is a charging state, μ_{d} is a discharging state, N_{bs} is a number of storage batteries, and N_{bs,max} is a maximum storage battery count.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Specific examples are used herein to explain the principles and implementations of the present disclosure. The description of the embodiments is merely intended to help understand the method of the present disclosure and its core ideas. In addition, those of ordinary skill in the art can make various modifications to the specific implementations and application scope in accordance with the teachings of the present disclosure. In conclusion, the content of the specification shall not be construed as limitations to the present disclosure.

What is claimed is:

1. An off-grid wind-hydrogen energy supply system for polar regions, comprising:
a wind power generation system, a cryogenic battery energy storage system, a hydrogen fuel cell system, and an intelligent monitoring system, wherein
the wind power generation system, the cryogenic battery energy storage system, the hydrogen fuel cell system, and the intelligent monitoring system are connected through a direct-current bus;
the wind power generation system is configured to: convert wind energy into electric energy, and charge the cryogenic battery energy storage system;
the hydrogen fuel cell system is configured to: convert chemical energy of hydrogen and oxygen into electric energy, and charge the cryogenic battery energy storage system;
the cryogenic battery energy storage system is configured to: store energy, mitigate a wind power fluctuation, and level a load fluctuation; and
the intelligent monitoring system is configured to obtain operation parameters of the wind power generation system, the cryogenic battery energy storage system, and the hydrogen fuel cell system.

2. The off-grid wind-hydrogen energy supply system for polar regions according to claim 1, wherein the wind power generation system comprises a fastening bracket, a wind generator, and a controller module, wherein
the wind generator is mounted on the fastening bracket; the wind generator is connected to the controller module; and the wind generator is separately connected to the wind power generation system, the hydrogen fuel cell system, and the intelligent monitoring system through the direct-current bus;
the wind generator is configured to: convert wind energy into electric energy, and charge the cryogenic battery energy storage system; and
the controller module is configured to: perform overcurrent limiting on the wind generator, and send an operation parameter of the wind generator to the intelligent monitoring system.

3. The off-grid wind-hydrogen energy supply system for polar regions according to claim 1, wherein the cryogenic battery energy storage system comprises:
a cryogenic battery pack and a bidirectional energy storage converter, wherein
the cryogenic battery pack is connected to the bidirectional energy storage converter; and the bidirectional energy storage converter is separately connected to the wind power generation system, the hydrogen fuel cell system, and the intelligent monitoring system through the direct-current bus;
the cryogenic battery pack is configured to: store energy, mitigate a wind power fluctuation, and level a load fluctuation; and
the bidirectional energy storage converter is configured to perform direct-current conversion.

4. The off-grid wind-hydrogen energy supply system for polar regions according to claim 1, wherein the hydrogen fuel cell system comprises:
a hydrogen controller, and an electrolytic hydrogen production unit, a hydrogen storage apparatus, and a hydrogen fuel cell power generator that are sequentially connected, wherein
the hydrogen fuel cell power generator is separately connected to the wind power generation system, the cryogenic battery energy storage system, and the intelligent monitoring system through the direct-current bus;
a switch is disposed between the hydrogen storage apparatus and the hydrogen fuel cell power generator;
the hydrogen controller is connected to the switch; and the hydrogen controller is configured to control an opening degree of the switch; and
the hydrogen fuel cell power generator is configured to: convert chemical energy of hydrogen and oxygen into electric energy, and charge the cryogenic battery energy storage system.

5. The off-grid wind-hydrogen energy supply system for polar regions according to claim 1, wherein the intelligent monitoring system comprises:
a micro-meteorological station, a global positioning system (GPS) module, a camera, an iridium module, an industrial control module, an MSP430 module, a power measurement module, a power distribution unit (PDU) module, and an industrial controller, wherein
the GPS module, the camera, and the iridium module are all connected to the MSP430 module; the micro-meteorological station, the MSP430 module, the power measurement module, the PDU module, and the industrial controller are all connected to the industrial control module; the iridium module is connected to a remote monitoring system; the industrial controller is separately connected to the wind power generation system and the hydrogen fuel cell system; and the power measurement module is connected to the PDU module and a plurality of electric devices;
the micro-meteorological station is configured to monitor real-time meteorological data;
the GPS module is configured to obtain position information;
the camera is configured to obtain environmental image information;
the industrial control module is configured to transmit real-time meteorological data and position information to the MSP430 module;
the MSP430 module is configured to transmit real-time meteorological data, position information, and environmental image information to the remote monitoring system through the iridium module;
the iridium module is further configured to obtain a control instruction;
the MSP430 module is further configured to transmit the control instruction;
the industrial control module is configured to transmit the control instruction;
the PDU module is configured to query, power on, power off, or reboot power supply for the plurality of electric devices;
the power measurement module is configured to obtain power of the plurality of electric devices; and
the industrial controller is configured to: collect data of a wind turbine controller and a hydrogen energy controller, and perform control and instruction delivery.

6. A control method of an off-grid wind-hydrogen energy supply system for polar regions, wherein the method is applied to the off-grid wind-hydrogen energy supply system for polar regions according to claim 1, and the control method comprises:
obtaining the operation parameter of the wind power generation system and the operation parameter of the cryogenic battery energy storage system;
constructing a wind turbine model based on the operation parameter of the wind power generation system;
constructing a storage battery model based on the operation parameter of the cryogenic battery energy storage system;
constructing a target function based on the wind turbine model and the storage battery model;
resolving, based on a constraint condition, the target function to minimize the target function, to obtain an optimal dispatch solution of the off-grid wind-hydrogen energy supply system for polar regions; and
dispatching the off-grid wind-hydrogen energy supply system for polar regions based on the optimal dispatch solution.

7. The control method of the off-grid wind-hydrogen energy supply system for polar regions according to claim 6, wherein the target function is as follows:
$${C}_{total} = α {C}_{E} + β {C}_{R} ,$$
wherein
Cₜₒₜₐₗ is the target function; α and β are weights; C_{E} is economic cost;
$${C}_{E} = {C}_{WT}^{Buy} + {C}_{BSS}^{Buy} + {C}_{WT}^{om} + {C}_{BSS}^{om} ; {C}_{WT}^{Buy}$$
is wind turbine purchase cost,
$${C}_{BSS}^{Buy}$$
is storage battery purchase cost,
$${C}_{WT}^{om}$$
is wind turbine operation cost,
$${C}_{BSS}^{om}$$
is storage battery operation cost, and C_{R} is reliability cost; C_{R}=P_{cur}ρ_{cur}; P_{cur} is a load curtailment volume; and ρ_{cur} is load curtailment penalty cost.

8. The control method of an off-grid wind-hydrogen energy supply system for polar regions according to claim 6, wherein the constraint condition comprises a power balance constraint, a wind turbine constraint, and a storage battery constraint;
the wind turbine constraint comprises a wind turbine power constraint, and a first numerical constraint; and
the storage battery constraint comprises a capacity-power relationship constraint, a charging/discharging constraint, a charging power constraint, a discharging power constraint, a storage battery capacity constraint, and a second numerical constraint.

9. The control method of an off-grid wind-hydrogen energy supply system for polar regions according to claim 8, wherein the power balance constraint is as follows:
$${P}_{wt} + {P}_{de} + {P}_{dis} - {P}_{ch} = \sum {P}_{load} - {P}_{cur} ;$$
the wind turbine power constraint is as follows:
$$0 \leq {P}_{wt , t} \leq {N}_{wt} {P}_{wt}^{max} ;$$
the first numerical constraint is as follows:
$$1 \leq {N}_{wt} \leq {N}_{wt , max} ;$$
the capacity-power relationship constraint is as follows:
$${C}_{bs} ( t ) = ( 1 - δ ) {C}_{bs} ( t - 1 ) - {P}_{dis} ( t ) / {η}_{d , bs} + {P}_{ch} {η}_{c , bs} ;$$
the charging/discharging constraint is as follows:
$${μ}_{c} + {μ}_{d} = 1 ;$$
the charging power constraint is as follows:
$$0 \leq {P}_{ch} \leq {μ}_{c} {P}_{ch}^{{max}_{bs}} ;$$
the discharging power constraint is as follows:
$$0 \leq {P}_{dis} \leq {μ}_{d} {P}_{dis}^{{max}_{bs}} ;$$
the storage battery capacity constraint is as follows:
$${N}_{bs} {C}_{bs , min} \leq {C}_{bs} t \leq {N}_{bs} {C}_{bs , max} ;$$
and
the second numerical constraint is as follows:
$$0 \leq {N}_{bs} \leq {N}_{bs , max} ,$$
wherein
P_{wt} is an actual wind turbine power, P_{de} is an output power of a diesel generator, P_{dis} is a storage battery discharging power, P_{dis} (t) is a storage battery discharging power at a moment t, η_{d,bs} is a storage battery discharging power, P_{ch} is a storage battery charging power,
$${P}_{ch}^{max}$$
is a maximum charging power,
$${P}_{dis}^{max}$$
maximum discharging power, ΣP_{load} is a total system load, P_{cur} is a load curtailment volume, P_{wt,t} is an actual wind turbine power at the moment t, N_{wt} is a number of wind turbines, N_{wt,max} is a maximum wind turbine count, C_{bs}(t) is an actual storage battery capacity at the moment t, C_{bs, min} is a minimum storage capacity of the storage battery, C_{bs, max} is a maximum storage capacity of the storage battery, C_{bs}(t−1) is an actual storage battery capacity at a moment t−1, δ is a self-discharging power of the storage battery, n_{dis} is a discharging efficiency, n_{c,bs} is a charging efficiency, u_{c} is a charging state, u_{d} is a discharging state, N_{bs} is a number of storage batteries, and N_{bs,max} is a maximum storage battery count.

10. The control method of the off-grid wind-hydrogen energy supply system for polar regions according to claim 6, wherein the wind power generation system comprises a fastening bracket, a wind generator, and a controller module, wherein
the wind generator is mounted on the fastening bracket; the wind generator is connected to the controller module; and the wind generator is separately connected to the wind power generation system, the hydrogen fuel cell system, and the intelligent monitoring system through the direct-current bus;
the wind generator is configured to: convert wind energy into electric energy, and charge the cryogenic battery energy storage system; and
the controller module is configured to: perform overcurrent limiting on the wind generator, and send an operation parameter of the wind generator to the intelligent monitoring system.

11. The control method of the off-grid wind-hydrogen energy supply system for polar regions according to claim 6, wherein the cryogenic battery energy storage system comprises:
a cryogenic battery pack and a bidirectional energy storage converter, wherein
the cryogenic battery pack is connected to the bidirectional energy storage converter; and the bidirectional energy storage converter is separately connected to the wind power generation system, the hydrogen fuel cell system, and the intelligent monitoring system through the direct-current bus;
the cryogenic battery pack is configured to: store energy, mitigate a wind power fluctuation, and level a load fluctuation; and
the bidirectional energy storage converter is configured to perform direct-current conversion.

12. The control method of the off-grid wind-hydrogen energy supply system for polar regions according to claim 6, wherein the hydrogen fuel cell system comprises:
a hydrogen controller, and an electrolytic hydrogen production unit, a hydrogen storage apparatus, and a hydrogen fuel cell power generator that are sequentially connected, wherein
the hydrogen fuel cell power generator is separately connected to the wind power generation system, the cryogenic battery energy storage system, and the intelligent monitoring system through the direct-current bus;
a switch is disposed between the hydrogen storage apparatus and the hydrogen fuel cell power generator;
the hydrogen controller is connected to the switch; and the hydrogen controller is configured to control an opening degree of the switch; and
the hydrogen fuel cell power generator is configured to: convert chemical energy of hydrogen and oxygen into electric energy, and charge the cryogenic battery energy storage system.

13. The control method of the off-grid wind-hydrogen energy supply system for polar regions according to claim 6, wherein the intelligent monitoring system comprises:
a micro-meteorological station, a global positioning system (GPS) module, a camera, an iridium module, an industrial control module, an MSP430 module, a power measurement module, a power distribution unit (PDU) module, and an industrial controller, wherein
the GPS module, the camera, and the iridium module are all connected to the MSP430 module;
the micro-meteorological station, the MSP430 module, the power measurement module, the PDU module, and the industrial controller are all connected to the industrial control module; the iridium module is connected to a remote monitoring system; the industrial controller is separately connected to the wind power generation system and the hydrogen fuel cell system; and the power measurement module is connected to the PDU module and a plurality of electric devices;
the micro-meteorological station is configured to monitor real-time meteorological data;
the GPS module is configured to obtain position information;
the camera is configured to obtain environmental image information;
the industrial control module is configured to transmit real-time meteorological data and position information to the MSP430 module;
the MSP430 module is configured to transmit real-time meteorological data, position information, and environmental image information to the remote monitoring system through the iridium module;
the iridium module is further configured to obtain a control instruction;
the MSP430 module is further configured to transmit the control instruction;
the industrial control module is configured to transmit the control instruction;
the PDU module is configured to query, power on, power off, or reboot power supply for the plurality of electric devices;
the power measurement module is configured to obtain power of the plurality of electric devices; and
the industrial controller is configured to: collect data of a wind turbine controller and a hydrogen energy controller, and perform control and instruction delivery.
